(19) United States
(12) Patent Application Publication
(10) Pub. No.: US 2008/0168862 A1
(43) Pub. Date: Jul. 17, 2008

(54) INERTIAL PROPULSION DEVICE

(76) Inventor: Michael K. Walden, North Las Vegas, NV (US)

Correspondence Address: SNELL & WILMER LLP (OC), 600 ANTON BOULEVARD, SUITE 1400, COSTA MESA, CA, 92626, US

(21) Appl. No.: 11/623,918

(22) Filed: Jan. 17, 2007

(51) Int. Cl. F03G 3/00

(52) U.S. Cl. 74/84 R

(57) ABSTRACT

An inertial propulsion unit converts centrifugal force to linear motion using two or more masses. The masses are connected to telescoping arms that rotate about a single axis. The rotating telescopic arms are guided along a closed path by a guide. The telescopic arms extend and retract as they rotate around the closed path changing the inertial moments of each of the telescopic arms. A resultant linear force from the rotating telescopic arms provides a propulsion force suitable for a vehicle.

### BACKGROUND OF THE INVENTION

1. Field of the Invention

The invention relates to propulsion devices. More particularly, the invention relates to propulsion devices that convert rotational forces into linear motion.

2. Description of Related Art

An object directed along a curved path will exert a force against the directing structure. The force is produced because an object that changes direction or speed is accelerating. The force produced is commonly referred to as centrifugal force and is directly proportional to the mass of the object, the radius of curvature of the curved path through which the object moves, and the square of the angular velocity of the spinning object. Thus, doubling the angular velocity (the number of revolutions per minute) of the object increases the centrifugal force exerted by a factor of four, while doubling the mass of the object or the radius only doubles the centrifugal force. This is shown in the following formula:

Radial G force=((Revolutions per sec)²*39.48*Radius in feet)/Gravitational acceleration in feet per second squared (32.14).

The centrifugal force produced by a body directed along a curved path is often expressed in units of “g's”. The centrifugal force in g's is the number of times larger the centrifugal force is than the force due to the normal pull of gravity. The g force may be a surprisingly large force. For example, an object rotating at a rate of five thousand revolutions per minute along a circular path with a radius of 12 inches generates a centrifugal force equal to 8488 times the normal pull of gravity.

A device that transforms the centrifugal force produced by a rotating body into a linear force may be used as a propulsion system on common transport vehicles, such as submersibles, boats, hovercraft, automobiles, trains, aircraft and space vehicles. In the past, attempts have been made to produce machines with such a propulsion system.

Many of these machines have rotating mass members that shift a mass to adjust the center of gravity relative to the axis of rotation. The result is a centrifugal force greater in the region where the mass has been shifted. By shifting the mass, the length of the radius of curvature of the mass also changes. The conservation of angular momentum causes a corresponding decrease in the speed of the mass as it is shifted away from the center of rotation. An example of a machine of this type is disclosed by Cook (U.S. Pat. No. 3,683,707).

Machines of this type, although workable, are not efficient enough to produce adequate linear force for general use. One problem with these machines is that they are limited in rotational speed by complex gear, shaft or pulley structures limiting their ability to fully exploit the velocity squared portion of the centrifugal force equation.

It has long been recognized by those skilled in the art that there is a need for propulsion devices that efficiently convert rotational force into a linear force. Applicant's invention addresses this need.

### SUMMARY OF THE INVENTION

It is, therefore, an object of the invention to provide a propulsion device that efficiently converts centrifugal force into linear force and linear movement.

Another object of the invention is to provide a propulsion device for a vehicle.

Still another object of the invention is to induce linear motion without frictional engagement of the vehicle with a surface of travel.

The invention provides a device for converting the force from a rotating mass to a linear force for propelling a vehicle. An arm having telescoping joints rotates about a pivot point. Dense masses may be positioned at the end of each telescoping joint to increase centrifugal force. The telescoping joints are guided by a guide that causes them to extend and retract as the arm rotates. The extending and retracting telescoping joints move the dense masses in a radial direction relative to the pivot point.

In one embodiment, the arm has two telescoping joints with one on each side of the pivot point and masses positioned at the ends of the telescoping joints. Each of the telescoping joints extends and retracts to complementary maximums and minimums every 180 degrees. At these points, there is a centrifugal force bias in favor of the portion of the arm that is maximally displaced. This bias begins 90 degrees of rotation prior to the maximum displacement and ends 90 degrees of rotation after the maximum displacement. At every point along this 180 degree arc of rotation, the mass on a first portion of the arm generates more force than the mass on a second portion of the arm.

The result of the arm having the pair of masses at different radii along the 180 degree arc of rotation is an imbalanced centrifugal force. The push of the extended mass cancels the reverse push of the retracted mass eliminating any “Stick-Slip” action. Stick-Slip action is found in many conventional revolving machine designs which make them unsuitable for use as propulsion devices in non-friction environments.

The centrifugal force imbalance may be converted into a linear unidirectional force component by mounting the arm on a wheeled or floating vehicle chassis. With the force component pointed away from the ground it can be used to lift an aircraft or space vehicle. With the force component pointed toward the ground it can act to increase traction in ground vehicles or force a submergible vehicle down.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a plan view of a single arm embodiment of the invention.

FIG. 2 is a plan view of a two arm embodiment of the invention showing the arms in a position of maximum linear force.

FIG. 3 is a plan view of the two arm embodiment of FIG. 2 showing the arms in a position of minimum linear force.

FIG. 4 is a plan view of a four arm embodiment of the invention.

FIG. 5 is a plan view of an embodiment of the invention having three degrees of rotational freedom.

### DETAILED DESCRIPTION

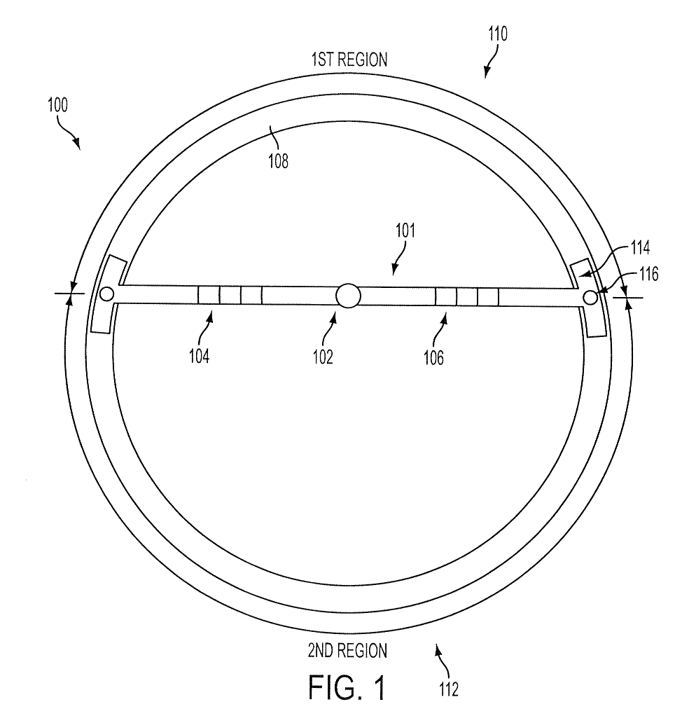

FIG. 1 shows a simplified embodiment of the propulsion device 100 of the invention. An arm 101 has a pivot point 102 that is affixed to a rotating means (not shown). The arm 101 has two telescoping portions 104 106 that allow each side of the arm 101 to independently extend and retract. Each side of the arm 101 is connected with a guide 108. The guide 108 center is offset from the pivot point 102. A pair of masses 114 may be attached to each end of the aim through a pair of pivots 116.

The rotating means (not shown) rotates the arm 101 about the pivot point 102. As the arm 101 rotates the guide 108 guides each side of the arm 101 along the path. The telescoping sections 104 and 106 extend and retract allowing each side of the arm 101 to traverse regions of varying radii. When the side of the arm 101 having telescoping section 104 traverses a first region 110 the side of the arm having telescoping section 106 traverses a second region 112. The side of the arm 101 traversing the first region 110 has a shorter length than the side of the arm 101 traversing the second region 112. The pair of masses 114 may be guided by the guide 108 along the path. The masses 114 may rotate to compensate for the varying radii of the path. The path may be substantially elliptical.

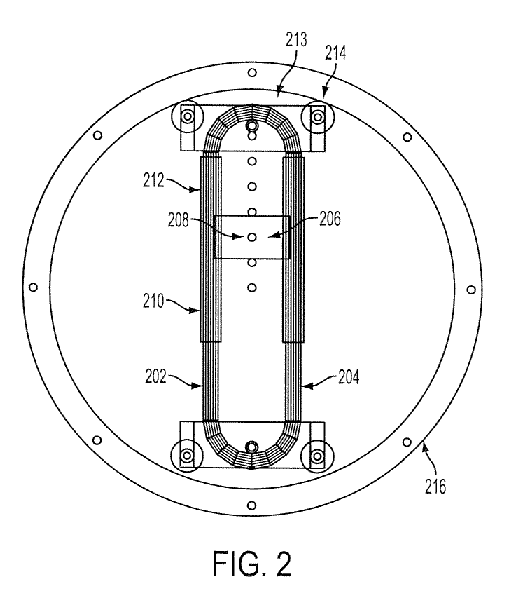

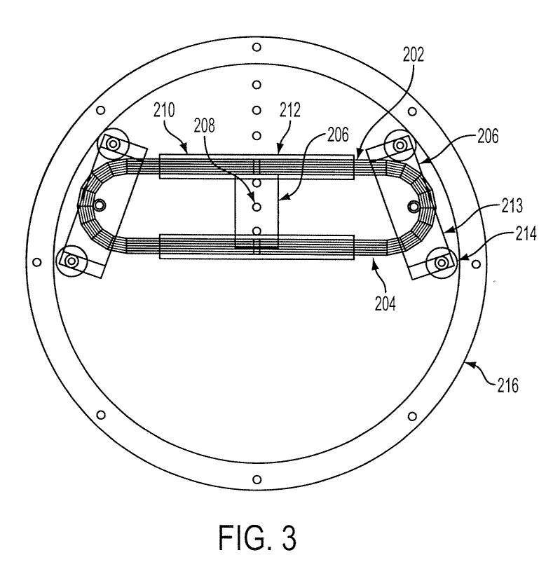

FIGS. 2 and 3 show a two armed embodiment of the invention. FIG. 2 shows the propulsion device in a position of maximum linear force and FIG. 3 shows the propulsion device in a position of minimum linear force. The first arm 202 and the second arm 204 have a brace 206 that is connected to a motor pinion 208. The arms 202 and 204 each have first 210 and second 212 telescoping portions. Each end of the arms 202 and 204 is connected to a mass carriage 213. The mass carriages 213 have wheels 214 that contact a guide 216. The center of the guide 216 is offset from the motor pinion 208.

The motor pinion 208 spins turning the brace 206 and the arms 202 and 204. The arms 202 and 204 rotate the mass carriages 213. The wheels 214 of the mass carriages 213 are guided along a path defined by the guide 216. As the mass carriages 213 rotate along the path, telescoping sections 210 and 212 of arms 202 and 204 extend and retract to accommodate the varying radial distances from the motor pinion 208 to the guide 216.

The force vectors of telescopic sections 210 and 212 are in opposite directions. The force vectors are generally of unequal magnitude due to the difference in rotation speed and radial distance of the mass carriages 213 from the motor pinion 208 as the mass carriages 213 traverse the path defined by the guide 216.

Through the use of several mathematical formulae it can be shown that the force vector of the extended portion of the telescopic arm is greater than the force vector of the retracted portion of the telescopic arm. The greater force vector cancels the lesser force vector and a resultant force in the direction of the greater force vector is apparent for any rotation angle except for the case when the telescopic arms 210 are extended equally, as shown in FIG. 3.

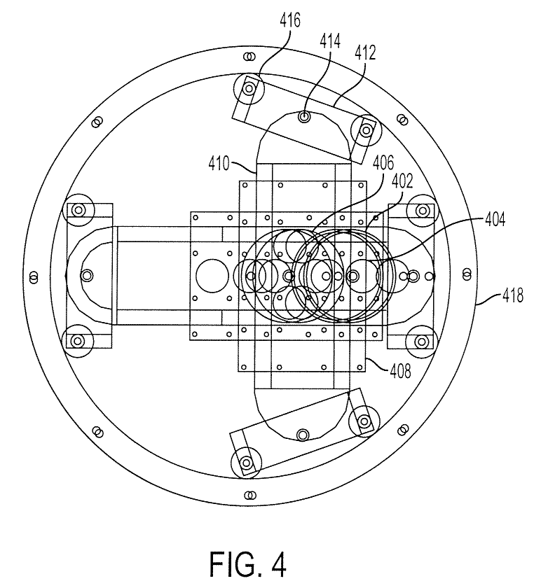

FIG. 4 shows a four arm embodiment of the invention. A motor 402 has a drive shaft with a pinion 404. The pinion 404 is connected to two arm gears 406. The two arm gears 406 are connected with two arm center units 408. The two arm center units 408 are arranged perpendicular to each other. The arm center units 408 each accommodate two slide-able arms 410. The slide-able arms 410 are each connected with a mass carriage 412 that pivots on a carriage pivot 414. The mass carriage 412 has wheels 416. The wheels 416 contact a guide 418. The guide 418 is offset from the rotation center of the arm center units 408.

The motor 402 turns the drive shaft and the pinion 404 turns the arm gears 406. The arm gears 406 turn the center units 408 and the slide-able arms 410. The slide-able arms 410 rotate, driving the mass carriages 412 along a path defined by the guide 418. The slide-able arms 410 translate in and out of the center units 408 to accommodate the varying distances from the rotation center to the guide 418.

During operation, the orthogonal mounting of pairs of slide-able arms 410 results in one pair of slide-able arms 410 maximally extended and a complementary pair of slide-able arms 410 maximally retracted when the other two slide-able arm 410 pairs are identically extended.

Having complementary mass carriages 414 in rotation eliminates the “Stick-Slip” Strong-Weak alternating force vector characteristic of conventional devices that convert rotation into a single directional force vector.

At the rotation angle where a slide-able arm 410 pair is maximally extended and the complementary slide-able arm 410 pair is maximally retracted, the slide-able arms 410 generate a centrifugal force vector, away from the rotational center point. The amount of force being proportional to the mass of the slide-able arms 410, the mass of the mass carriage 412, wheels 416, any other mass that slides with the slide-able arms 410, the velocity and radial distance from the center of rotation.

This embodiment eliminates the zero force vector point shown in FIG. 3 when the two telescoping arms 210 and 212 are extended equally. When pairs of slide-arms are equally extended, there is a pair of slide-able arms 410 maximally extended and a complementary pair of slide-able arms 410 maximally retracted.

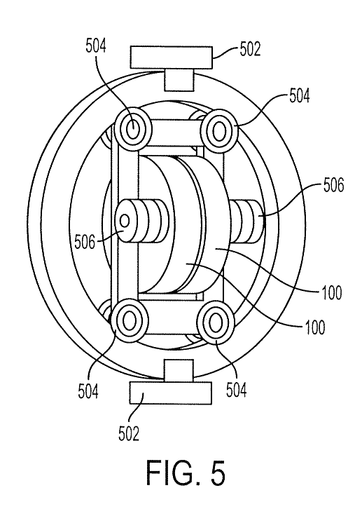

FIG. 5 is a detailed view of a three degree of freedom embodiment of the invention. Two propulsion devices 100 are mounted in a gimbal having three degrees of freedom. A first set of pivots 502 provides the first degree of rotational freedom. A second set of pivots 504 provides the second degree of rotational freedom. A third set of pivots 506 provides the third degree of rotational freedom.

The gimbal system may be mounted in a vehicle chassis to allow the vehicle to rotate relative to the force vector. The gimbal system allows the vehicle to change its pitch, roll and heading relative to the force vector.

Two propulsion devices having opposite arm rotation direction may be mounted next to each other canceling the torque effects generated by the devices themselves.

A set of gyroscopic controllers and sensors may be mounted on or near the gimbal system to monitor the angular position pivots 502, 504 and 506 and control the direction of the force vector. The gimbal system allows the vehicle to rotate about all three rotational axes.

What is claimed is:

1. An apparatus for converting rotational motion into linear force, the apparatus comprising:
an arm having a pivot point and a first telescoping portion on a first side of the pivot point and a second telescoping portion on a second side of the pivot point;
a rotating device for rotating the arm about the pivot point; and
a guide for guiding the first and second telescoping portions along a path, the guide having a first region shaped to extend the telescoping portions and a second region shaped to retract the telescoping portions;
wherein the first and second telescoping portions extend and retract during arm rotation to produce asymmetric centrifugal forces that sum to produce a linear force.

2. The apparatus of claim 1 wherein the first telescoping portion rotates through the first region at substantially the same time the second telescoping portion rotates through the second region.

3. The apparatus of claim 1 wherein the rotating device is a motor.

4. The apparatus of claim 1 wherein the path is substantially elliptical and the pivot point is located substantially near a focal point of the path.

5. The apparatus of claim 1 wherein the path is substantially circularly and the pivot point is offset from the center of the path.

6. The apparatus according of claim 1 further comprising a first dense member connected with the first telescoping portion through a first pivot.

7. The apparatus according of claim 6 further comprising a second dense member connected with the second telescoping portion through a second pivot.

8. The apparatus of claim 7 wherein the first dense member and the second dense member have substantially the same mass.

9. The apparatus of claim 1 wherein the guide includes a component selected from a list of components consisting of a bearing, a wheel, a lubricated slide and a magnetic slide.

10. The apparatus of claim 9 further comprising a pivot joint connected with the arm and the component for keeping the component in contact with the guide.

11. The apparatus of claim 1 wherein the arm is magnetically charged and the guide is magnetically charged reducing friction between the arm and the guide.

12. The apparatus of claim 11 wherein the magnetic force between the aim and the guide moves the arm.

13. The apparatus of claim 1 further comprising a chassis connected with the rotating device.

14. The apparatus of claim 1 further comprising a gimbal coupled with the aim for mounting in a vehicle chassis.

15. An apparatus for extracting a linear force from a magnetic field using rotational motion, the apparatus comprising:
an arm having a pivot point and first and second telescoping portions extending from the pivot point;
a motor for rotating the arm around the pivot point; and
a guide for guiding the first and second telescoping portions along a path, the guide having a first region shaped to extend the telescoping portions and a second region shaped to retract the telescoping portions;
wherein the first and second telescoping portions extend and retract during arm rotation each telescoping portion producing asymmetric centrifugal forces that sum to produce a linear force.

16. The apparatus of claim 15 further comprising a gimbal coupled with the arm for mounting in a vehicle chassis.
